(19) United States
(12) Patent Application Publication
(10) Pub. No.: US 2020/0031693 A1
(43) Pub. Date: Jan. 30, 2020

(54) Device for manufacturing magnetized water

(71) Applicants: Sang Moo Lee, Seongnam-si (KR); Dae Ho Park, Namyangju-si (KR)

(72) Inventors: Sang Moo Lee, Seongnam-si (KR); Dae Ho Park, Namyangju-si (KR)

(21) Appl. No.: 16/253,565

(22) Filed: Jan. 22, 2019

(30) Foreign Application Priority Data
Jul. 24, 2018 (KR) 10-2018-0085997

(51) Int. Cl. C02F 1/48

(52) U.S. Cl. CPC C02F 1/481; B03C 1/28

(57) ABSTRACT

The present invention relates to a device for manufacturing magnetized water including: an outer case; an adapter coupled to one end or both ends of the outer case; a magnet case having a body, accommodation portions facing each other, and end caps disposed on both longitudinal ends of the body; magnet parts each having a plurality of permanent magnets serially continuously arranged and accommodated in each accommodation portion; spacers insertedly disposed between the permanent magnets; and shield steel plates coupled to the magnet case, wherein attractive force generation arrangements and repulsive force generation arrangements of the permanent magnets are arbitrarily changed by means of the magnet case and the end caps separably coupled to each other.

### BACKGROUND OF THE INVENTION

### Field of the Invention

The present invention relates to a device for manufacturing magnetized water, and more particularly, to a device for manufacturing magnetized water that is configured to have a magnet case adapted to arbitrarily change arrangements of permanent magnets of a magnet part to arbitrarily adjust attractive and repulsive force generation arrangements of the permanent magnets in such a manner as to optimize water ionization capability or lime dissolution capability according to use purposes of water, thereby producing the magnetized water adequate for the use purposes thereof, and that is configured to provide the magnet case easily coupled to and separated from an outer case and an adapter in which the magnet case is accommodated.

### Background of the Related Art

A device for manufacturing magnetized water used widely in a conventional practice is configured to place magnets in a pipe to allow water to pass through the magnets, so that polarity of water molecules is changed by means of the magnetic forces of the magnets to thus magnetize the water.

One example of the conventional devices for manufacturing magnetized water is disclosed in Korean Utility Model Registration No. 20-0437393 (on Nov. 22, 2007 and entitled ‘apparatus for producing magnetized hexagonal water using a magnetizer’), and in the prior art, circular permanent magnets are continuously arranged to generate repulsive forces therebetween, and after spacers made of steel plates are inserted into the adjacent permanent magnets, a long bolt is fixedly fitted to the permanent magnet and the spacer adjacent to each other. According to the conventional device, the surface tension of water is changed small in a water molecular structure through magnetic effects, thereby allowing all kinds of mineral components contained in water to usefully respond to a human body, and after the permanent magnets having 12,000 to 13,000 gauss are arranged to generate the repulsive forces therefrom, the spacers are inserted into the space between the adjacent permanent magnets, thereby arranging the permanent magnets at given intervals, so that the strength of the magnetic field and the densities of the magnets are increased, and thus, water passes through the magnets in such a manner as to be changed to the magnetized hexagonal water having small surface tension in circulating water.

Other examples of the conventional devices are disclosed in Korean Patent No. 10-093844 (on Jan. 15, 2010 and entitled ‘magnetization treatment device’) and in Korean Patent Application Laid-open No. 10-2010-0034585 (on Apr. 1, 2010 and entitled ‘magnetic rod and apparatus for magnetic treatment of water using the same’), which suggest magnetization treatment devices for magnetizing water molecules through the repulsive force generation arrangements of permanent magnets.

According to the features of the three prior arts as mentioned above, only the repulsive forces are generated from the serial arrangements of the permanent magnets. Like this, if the permanent magnets are arranged with the same polarity as each other, it is hard to expect that magnetized water treatment performance caused by magnetic forces is varied according to different polarity arrangements of the permanent magnets.

So as to solve the above-mentioned problems, the arrangements of the permanent magnets wherein the attractive forces and the repulsive forces are mixedly generated have been proposed.

Such conventional examples are disclosed in Korean Patent No. 10-1363629 (on Feb. 10, 2014 and entitled ‘magnetization treatment device for industry’) and in Korean Patent No. 10-1363632 (on Feb. 10, 2014 and entitled ‘coupling type magnetization treatment device for emitting far-infrared ray and negative ion’), which are configured to have attractive forces generation arrangements and repulsive force generation arrangements are mixed in the polarity arrangements of permanent magnets, thereby optimizing water atomization and activation efficiencies.

According to the two prior arts, however, a magnet case in which the permanent magnets are accommodated is basically housed in accommodation spaces formed in an outer case and an adapter, but the accommodation spaces formed in the outer case and the adapter, in which the magnet case is housed, are spaced apart from the magnet case by a given distance, thereby forming an isolated space. Further, germanium activated charcoal is filled in the isolated space to allow the magnet case to be fixed to the accommodation spaces and at the same time to supply negative ions from the germanium activated charcoal. Under the above-mentioned configuration, accordingly, it is impossible to separate the magnet case from the accommodation spaces after the magnet case has been housed fixedly in the accommodation spaces of the outer case and the adapter by means of the filling of the germanium activated charcoal.

Through the above-mentioned prior arts and the experiments of this inventor, it can be appreciated that a degree of ionization of water and lime dissolution capability of water are differently obtained according to attractive and repulsive force generation arrangements of permanent magnets. If the attractive force generation arrangements of the permanent magnets are larger than the repulsive force generation arrangements thereof, in this case, the lime dissolution capability of water is improved, and if the repulsive force generation arrangements of the permanent magnets are larger than the attractive force generation arrangements thereof, the ionization capability of water is improved.

If the attractive and repulsive force generation arrangements of the permanent magnets are adjusted, the magnetized water can be customizedly produced according to the use purposes thereof. According to the above-mentioned prior arts, however, it is impossible to arbitrarily adjust the arrangements of the permanent magnets according to the use purposes of the water.

### SUMMARY OF THE INVENTION

Accordingly, the present invention has been made in view of the above-mentioned problems occurring in the prior art, and it is an object of the present invention to provide a device for manufacturing magnetized water that is configured to allow attractive and repulsive force generation arrangements of permanent magnets to be arbitrarily changed, to optimize water ionization capability or lime dissolution capability according to use purposes of water, and to provide a magnet case easily coupled to and separated from an outer case and an adapter in which the magnet case is accommodated so as to allow the arrangements of the permanent magnets to be easily changed.

It is another object of the present invention to provide a device for manufacturing magnetized water that is capable of allowing at least two or more configurations each having accommodation portions facingly disposed, while placing at least two or more flow paths formed in one way therebetween, to be arranged on a horizontal line, so that the distance between the accommodation portions becomes reduced to maximize the magnetization capability for the same volume, and of course, a capacity of magnetization is increased through the plurality of flow paths to allow a large amount of water to be magnetized.

To accomplish the above-mentioned objects, according to the present invention, there is provided a device for manufacturing magnetized water including: an outer case formed of a through-body; an adapter formed of a through-body in such a manner as to be coupled to one end or both ends of the outer case; a magnet case separably accommodated in a through space formed by means of coupling of the outer case and the adapter and having a body, accommodation portions facing each other in such a manner as to place a flow path formed in a longitudinal direction of the body therebetween, and end caps disposed on both longitudinal ends of the body in such a manner as to be coupled openably and closably to both ends of the accommodation portions, each end cap having a through hole formed thereon to correspond to the flow path; magnet parts each having a plurality of permanent magnets serially continuously arranged and accommodated in each accommodation portion in such a manner as to apply attractive forces to be generated between the accommodation portions in directions facing the accommodation portions, the permanent magnets having at least one or more repulsive force generation arrangements in the serially continuous arrangements thereof; spacers insertedly disposed between the permanent magnets from which the attractive forces are generated in the serially continuous arrangements of the permanent magnets in each accommodation portion; and shield steel plates coupled to the magnet case by means of the magnetic forces of the permanent magnets accommodated in the accommodation portions in such a manner as to cover the longitudinal outer peripheral surfaces of the accommodation portions, wherein the attractive force generation arrangements and the repulsive force generation arrangements of the permanent magnets are arbitrarily changed by means of the magnet case and the end caps separably coupled to each other.

According to the present invention, desirably, if two or more flow paths are formed in the magnet case, the flow paths are formed in one way on a vertical section with respect to the longitudinal direction of the body, and the accommodation portions face each other on one way line along which the flow paths are formed in such a manner as to place each flow path therebetween, both end accommodation portions on one way line being covered with the shield steel plates, so that one set is formed, and one or more sets are formed on a horizontal line.

According to the present invention, desirably, the accommodation portions formed on the longitudinal outer peripheral surfaces of the magnet case have open ends formed on outer peripheral surfaces thereof, so that the attractive force generation arrangements and the repulsive force generation arrangements of the permanent magnets are arbitrarily changed through the open ends, and the open ends are shielded by means of the shield steel plates.

According to the present invention, desirably, each magnet part includes six permanent magnets arranged continuously serially in each accommodation portion in such a manner as to have the repulsive force generation arrangements on both ends of the serially continuous arrangements of the permanent magnets.

According to the present invention, desirably, each magnet part includes four to six permanent magnets arranged continuously serially in each accommodation portion, and if the permanent magnets less than six are accommodated in each accommodation portion, a filling body, which has the same size as each permanent magnet, is filled in the empty space of the permanent magnet.

According to the present invention, desirably, the device further includes an exchange slider having an accommodation space, support ends disposed on both longitudinal ends of the accommodation space, and support bars formed on three surfaces thereof to supportingly connect the support ends thereto, so that after the magnet part is accommodated in the accommodation space of the exchange slider, the exchange slider is accommodated in the accommodation portion.

According to the present invention, desirably, the body having two or more flow paths in one way on the vertical section with respect to the longitudinal direction of the magnet case includes: end bodies each having a half flow path left with half of each flow path and the accommodation portion whose open end or closed end is formed on the outer surface facing the half flow path; and a connection body having half flow paths facingly formed on both sides thereof, while placing the accommodation portion therebetween, in such a manner as to correspond to the half flow paths of the end bodies, so that the half flow path of the connection body or the end body is coupledly connected to both side half flow paths of the connection body to form the body, and the end bodies are disposed on both ends of the body coupled in one way.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1a and 1b are exploded perspective and sectional views showing a device for manufacturing magnetized water according to a first embodiment of the present invention;

FIGS. 2a and 2b are exploded perspective and sectional views showing a device for manufacturing magnetized water according to a second embodiment of the present invention;

FIGS. 3a, 3b, 3c and 3d are front views showing accommodation portions, flow paths, and shield steel plates in the device according to the present invention;

FIG. 4 is an exploded perspective view showing a set of a magnet case in which two or more flow paths are formed in one way in the device according to the present invention; and

FIGS. 5a, 5b, 5c and 5d are side views showing arrangements of permanent magnets according to the present invention.

### DETAILED DESCRIPTION OF THE PREFERRED EMBODIMENTS

Hereinafter, an explanation on a device for manufacturing magnetized water according to the present invention will be in detail given with reference to the attached drawings.

According to a first embodiment of the present invention, the device for manufacturing magnetized water is configured to have magnet parts 40, spacers 50 and shield steel plates 60 coupled to a magnet case 30 and then accommodated in a through-space formed by means of coupling between an outer case 10 and an adapter 20, which are formed of through-bodies in such a manner as to be screw-coupled to each other.

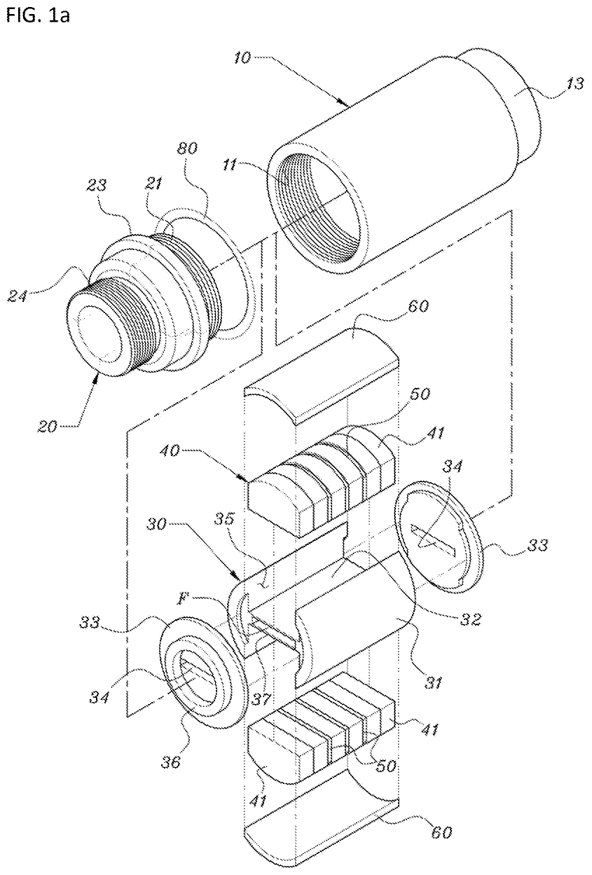

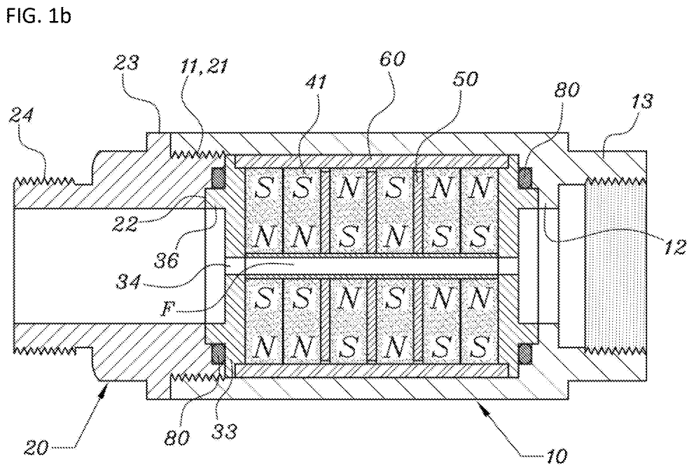

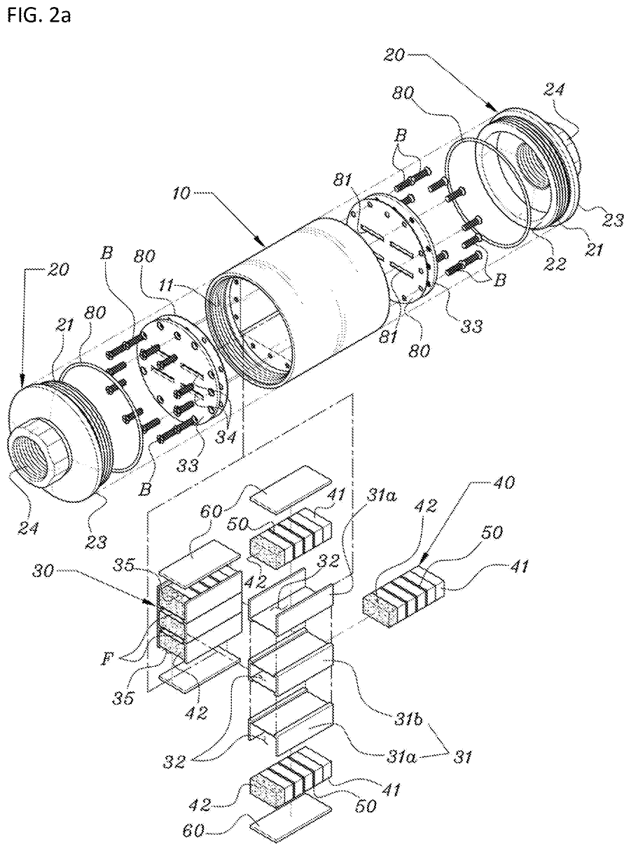

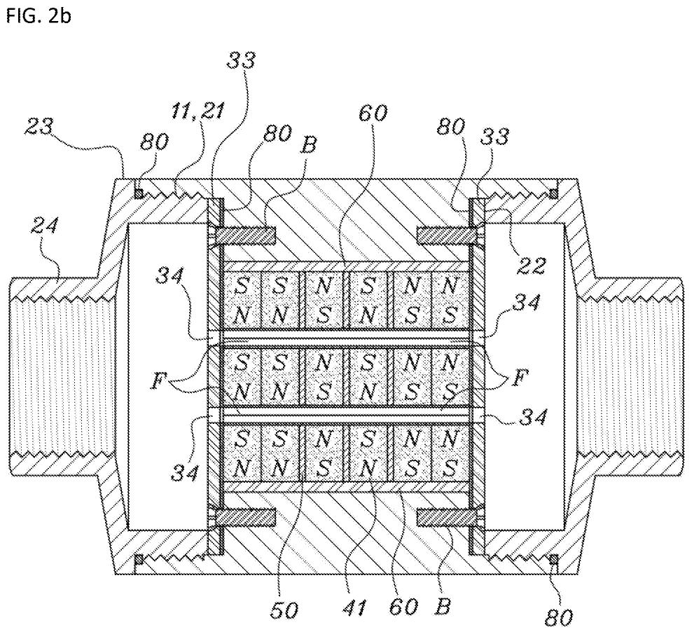

The magnet case 30 includes a body 31 having a flow path F formed in a longitudinal direction thereof, accommodation portions 32 facing each other in such a manner as to place the flow path F therebetween, and end caps 33 disposed on longitudinal ends of the body 31 in such a manner as to be coupled openably and closably to both longitudinal ends of the accommodation portions 32, each end cap 33 having a through hole 34 formed thereon to correspond to the flow path F. In this case, the openable and closable coupling includes both of fitting coupling as shown in FIG. 1a and screw coupling as shown in FIG. 2a.

Further, the accommodation portions 32 are formed symmetrically on both sides of the flow path F, while placing the flow path F therebetween, on a vertical section with respect to the longitudinal direction of the magnet case 30, and accordingly, the accommodation portions 32 and the flow path F are placed on the same line in one way. The accommodation portions 32 on the same line as the flow path F have open ends 35 or closed ends 35′ formed on both end surfaces thereof. Desirably, the accommodation portions 32 have the open ends 35 being in an open state in the longitudinal direction of the body 31.

Each magnet part 40 has a plurality of permanent magnets 41 continuously serially arranged and accommodated in each of the accommodation portions 32 symmetrically disposed with respect to the flow path F. In this case, the magnet parts 40 are arranged to apply attractive forces to be generated between the accommodation portions 32 placing the flow path F therebetween, and at this time, at least one or more repulsive force generation arrangements are made in the serially continuous arrangements of the plurality of permanent magnets 41 in the respective accommodation portions 32.

Further, the spacers 50 are insertedly disposed between the adjacent permanent magnets 41 from which the attractive forces are generated in the plurality of permanent magnets 41 arranged continuously serially in the respective accommodation portions 32. As a distance between the permanent magnets 41 arranged continuously serially becomes long, generally, the magnetic forces of the permanent magnets 41 become weakened. Accordingly, desirably, a thickness of each spacer 50 is in a range of 1.0 to 5.0 mm.

The magnet parts 40 and the spacers 50 are accommodated in the accommodation portions 32 of the magnet case 30. Their accommodation is carried out by means of two methods as will be discussed below. The first method is carried out by accommodating the magnet parts 40 and the spacers 50 in the accommodation portions 32 of the magnet case 30 through the open ends 35 since the magnet case 30 desirably has the open ends 35 formed in the longitudinal direction of the body 31, and the second method is carried out as follows. The magnet case 30 has the end caps 33 disposed on both longitudinal ends of the body 31 to openably and closably cover the accommodation portions 32. Accordingly, if any one (and/or both) of the end caps 33 coupled to both ends of the body 31 is separated from the body 31, one longitudinal end (and/or both longitudinal ends) of the accommodation portions 32 is (are) open, so that the magnet parts and the spacers 50 are accommodated in the accommodation portions 32 of the magnet case 30 through one longitudinal end of the open accommodation portions 32. The two accommodation methods are selected appropriately according to given situations.

According to the present invention, the magnet parts 40 and the spacers 50 are freely accommodated in and drawn from the accommodation portions 32.

If the magnet parts 40 and the spacers 50 are drawn from the accommodation portions 32, first, the magnet parts 40 and/or the spacers 50 are all or individually drawn through the open ends 35. Contrarily, if the magnet parts 40 and/or the spacers 50 are drawn from the accommodation portions 32 through the end caps 33 coupled to both ends of the body 31, the end caps 33 are removed from both ends of the body 31. Next, if a pushing force is applied from one longitudinal end of the body 31 to the other end thereof, the magnet parts 40 and the spacers 50 are drawn from the accommodation portions 32 through the other side end of the body 31.

If the open ends 35 are formed on the accommodation portions 32, the shield steel plates 60 serve to shield the open ends 35. The shield steel plates 60 are conductors so that they can be coupled to the open ends 35 of the accommodation portions 32 only with the magnetic forces of the permanent magnets 41 accommodated in the accommodation portions 32, without having any separate fastening means. Of course, each shield steel plate 60 may have a double structure so that a conductor is disposed on a surface coming into contact with the magnet part 40 and a non-conductor is disposed on the opposite surface to the surface coming into contact with the magnet part 40.

Under the above-mentioned configuration, hereinafter, the device for manufacturing magnetized water according to the first and second embodiments of the present invention will be in detail explained.

As shown in FIGS. 1a and 1b, the outer case 10 is formed of the through-body in such a manner as to allow the adapter 20 to be screw-coupled to one end or both ends thereof. In case where the adapter 20 is screw-coupled to one end of the outer case 10, as shown in FIGS. 1a and 1b, the outer case 10 includes a thread portion 11 formed on the inner peripheral surface of one end thereof, a protruding support step 12 protruding from the inner peripheral surface close to the other end portion thereof, and a connection end 13 formed on the end periphery of the other end thereof. Contrarily, in case where the adapters 20 are coupled to both ends of the outer case 10, as shown in FIGS. 2a and 2b, the protruding support step 12 and the connection end 13 of the outer case 10 are replaced with inward support steps 22 and spiral connection ends 24 of the adapters 20, which perform the same functions as the protruding support end 12 and the connection end 13.

The adapter 20, which is formed of the through-body, includes a spiral coupling portion 21 formed on the other end thereof in such a manner as to be screw-coupled to the thread portion 11 of the outer case 10, the inward support step 22 formed as a stepped projection in such a manner as to be reduced in diameter inward from the end periphery of the spiral coupling portion 21, an extended support rim 23 having a diameter extended from the spiral coupling portion 21 in such a manner as to be supported against one end surface of the outer case 10, and the spiral connection end 24 formed on one end thereof.

Connection pipes (not shown) are connected to the connection end 13 of the outer case 10 and to the spiral connection end 24 of the adapter 20.

As shown in FIGS. 1a and 1b, each end cap 33 has a protruding rim 36 protrudingly from the outer end portion thereof in such a manner as to be reduced in diameter. At the time when the magnet case 30 is coupled to the through-space formed by means of coupling between the outer case 10 and the adapter 20, the protruding rim 36 functions to allow the magnet case 30 to be supportedly contacted with the protruding support step 12 of the outer case 10 and the inward support step 22 of the adapter 20, so that the magnet case 30 can be stably supported against the through-space. Further, sealing means 80 are desirably provided between the protruding support step 12 and the protruding rim 36 of one side end cap 33 and between the inward support step 22 and the protruding rim 36 of the other side end cap 33, thereby ensuring water-tightness. In this case, the sealing means 80 are sealing rings (See FIGS. 1a and 1b) and sealing pads (See FIGS. 2a and 2b). If the sealing means 80 formed of the sealing pads are disposed between the end caps 33 of the magnet case 30 and the body 31, as shown in FIGS. 2a and 2b, each sealing pad 80 has through-windows 81 formed thereon in such a manner as to be located on extended lines from the through holes 34 of the corresponding end cap 33, thereby preventing a stream of fluid from being inhibited.

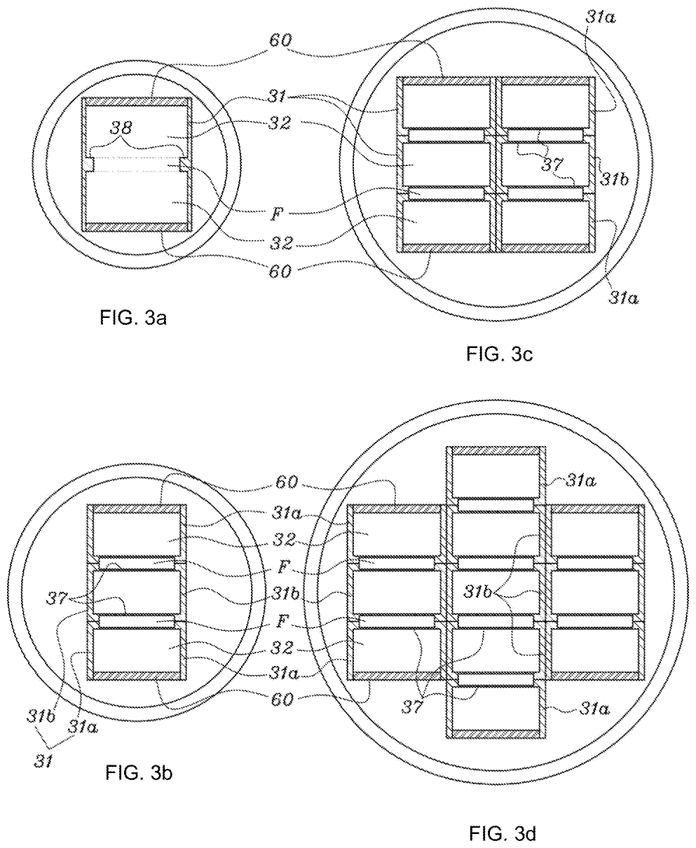

FIG. 3a shows basic arrangements of the accommodation portions 32 and the shield steel plates 60 around the flow path F, and in this case, one flow path F is provided. FIGS. 3b to 3d show, if two or more flow paths F are formed in one way, arrangements of the accommodation portions 32 and the shield steel plates 60 around the flow paths F.

FIG. 3a shows one flow path F formed in the longitudinal direction of the body 31. Further, the accommodation portions 32 face each other in such a manner as to place the flow path F therebetween, and the shield steel plates 60 are coupled to the open ends 35 of the accommodation portions 32 disposed on both ends on one way line of the accommodation portions 32. Such components constitute one set, and of course, two sets may be arranged on a horizontal line.

In one set wherein the shield steel plate 60, the accommodation portion 32, the flow path F, the accommodation portion 32, and the shield steel plate 60 are arranged sequentially, as shown in FIG. 3a, if two flow paths F are provided in one way line on a vertical section with respect to the longitudinal direction of the body 31, components of one set are changed to those of one set as shown in FIG. 3b. Even though the components of one set are changed, the flow paths F and the accommodation portions 32 are arranged in one way on the vertical section with respect to the longitudinal direction of the body 31, and the shield steel plates 60 are coupled to the open ends 35 of the accommodation portions 32 disposed on both ends on one way line of the accommodation portions 32. Two or more sets, each set having the components arranged on the same line as each other, may be arranged on the horizontal line, which are shown in FIGS. 3c and 3d.

If two or more flow paths F are formed in the magnet case 30 on one way line, the accommodation portions 32 are not repeatedly formed by the respective flow paths F so as to face each other around the flow paths F, but only one accommodation portion 32 is formed between the flow paths F. In case of the formation of the two flow paths F, in detail, the accommodation portion 32, the flow path F, the accommodation portion 32, the accommodation portion 32, the flow path F, and the accommodation portion 32 are not arranged sequentially, but as shown in FIG. 3b, the accommodation portion 32, the flow path F, the accommodation portion 32, the flow path F, and the accommodation portion 32 are arranged sequentially. Under the above-mentioned configuration, the whole volume of the magnet case 30 is reduced, and of course, the manufacturing cost is lowered to give many economical advantages.

Further, as shown in FIGS. 3b to 3d, a partition wall 37 is disposed between the accommodation portion 32 and the flow path F, and otherwise, as shown in FIG. 3a, a seating projection 38 is formed between the accommodation portion 32 and the flow path F to stably seat the permanent magnets 41 thereon.

On the other hand, the accommodation portions 32 disposed on both ends on one way line of the accommodation portions 32 desirably have the open ends 35, and after the shield steel plates 60 are separated from the magnet case 30, accordingly, the magnet parts 40 are easily exchanged through the open ends 35 of the accommodation portions 32. As shown in FIGS. 3b to 3d, even in case where the accommodation portions 32 are surrounded with the flow paths F, the end caps 33 coupled to both longitudinal ends of the body 31 are separated from the magnet case 30, and after that, the magnet parts 40 are easily exchanged through the end caps 33.

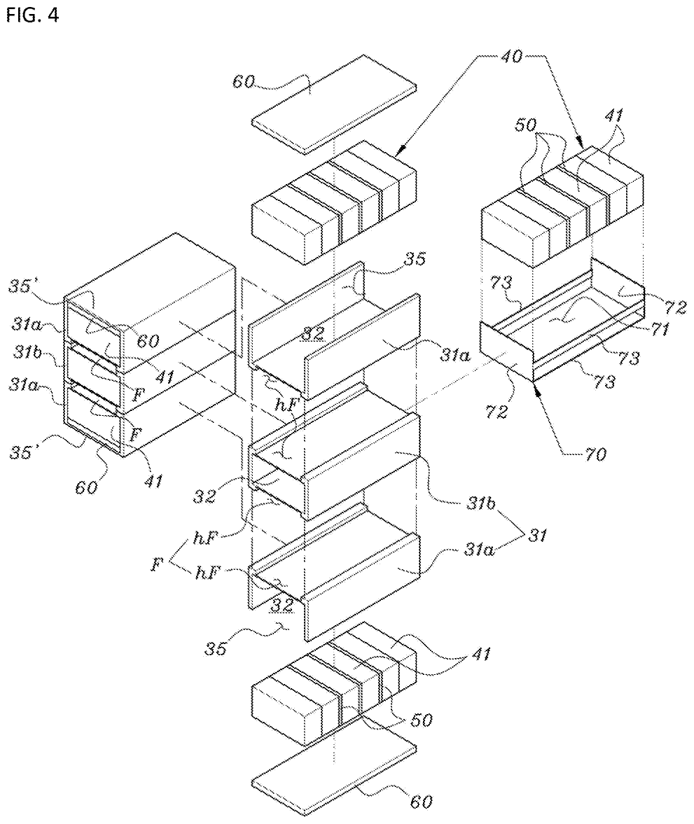

As shown in FIGS. 3b to 3d, the body 31 having two or more flow paths F in one way on the vertical section with respect to the longitudinal direction thereof is changed in a combination of a set composed of end bodies 31a and a connection body 31b, thereby making several combinations in which two or more flow paths F are formed on one set. The configurations of the end bodies 31a and the connection body 31b of the body 31 will be easily understood with reference to FIG. 4.

Each end body 31a has a half flow path hF left with half of the flow path F on one end portion thereof when the flow path F formed in the longitudinal direction of the body 31 is viewed on the vertical section with respect to the longitudinal direction of the body 31 and the accommodation portion 32 formed on the other end portion corresponding to the surface facing the half flow path hF and having the open end 35 or closed end 35′ formed on top thereof.

The connection body 31b has half flow paths hF facingly formed on one end portion thereof and the other end portion thereof, while placing the accommodation portion 32 therebetween, in such a manner as to correspond to the half flow paths hF of the end bodies 31a.

If the end bodies 31a are coupledly connected to both side half flow paths hF of the connection body 31b, the configuration as shown in FIG. 3b is made. Further, if one or more sets each having such configuration as shown in FIG. 3b are arranged in a horizontal direction, the configuration as shown in FIG. 3c is made. In this case, coupling between the connection body 31b and the end bodies 31a and coupling between the respective sets are carried out by means of known methods, desirably, ultrasonic welding.

Further, another set, in which three connection bodies 31b are connected sequentially and the end bodies 31a are connected to both end connection bodies 31b, is inserted between the sets each having the end bodies 31a are coupled to both sides of the connection body 31b as shown in FIG. 3c, and if the respective sets are connected to one set, the configuration as shown in FIG. 3d is made.

Like this, the body 31 is composed of the end bodies 31a and the connection bodies 31b, and the end bodies 31a and the connection bodies 31b are freely connected to one another, thereby advantageously obtaining various configurations in one set having the two or more flow paths F formed in one way on the vertical section with respect to the longitudinal direction of the body 31. As a result, the end bodies 31a and the connection bodies 31b are appropriately configured according to their need, and such configuration and/or other configurations are coupledly arranged on the horizontal line, thereby advantageously conforming to various pipe sizes. Accordingly, there is no need to separately make the magnet case 30 by pipe size, thereby giving many economical advantages.

According to the present invention, on the other hand, the device further includes an exchange slider 70 as shown in FIG. 4 adapted to help the magnet part 40 more easily exchanged in the accommodation portion 32.

After the magnet part 40 is in advance accommodated in the exchange slider 70, the magnet part 40 integrated with the exchange slider 70 is inserted into the accommodation portion 32 or separated from the accommodation portion 32, and in this case, the exchange slider 70 has a shape of a box open on a top surface thereof to easily accommodate the magnet part 40 therein. Desirably, the exchange slider 70 has an accommodation space 71, support ends 72 disposed on both longitudinal ends of the accommodation space 71, and support bars 73 formed on three surfaces thereof to supportingly connect the support ends 72 thereto. Like this, the exchange slider 70 is open on one surface of the accommodation space 71 in the longitudinal direction thereof, and accordingly, the magnet part 40 is easily inserted in the accommodation space 71 through the open one surface of the exchange slider 70. The inserted magnet part 40 is fittedly fixed to the insides of the support bars 73 connecting both side support ends 72. After the magnet part 40 is inserted into the exchange slider 70, one side end of the exchange slider 70 is mounted on one side end of the accommodation portion 32 from which the end cap 33 is open, and next, the other side end of the exchange slider 70 is pushed. If so, one side end of the exchanger slider 70 is pushedly inserted until coming into close contact with the end cap 33 coupled to the other side end of the accommodation portion 32, so that the exchange slider 70 is completely accommodated in the accommodation portion 32.

On the other hand, the present invention, which is configured to easily exchange the magnet parts 40 from the magnet case 30, can easily change the arrangements of the permanent magnets 41 of each magnet part 40.

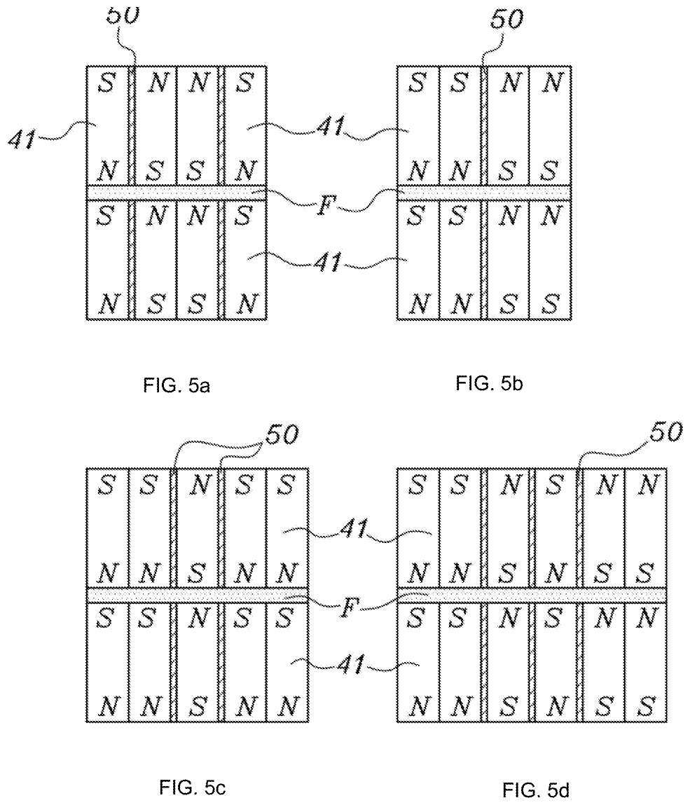

FIGS. 5a to 5d are side views showing arrangements of the permanent magnets 41 according to the present invention.

First, the sizes of pipes commercialized for household or industry are limited. Accordingly, the device for manufacturing magnetized water according to the present invention has to be installed within the size of the commercialized pipe. As a result, the size of the magnet case 30 is limited, and of course, the magnet parts 40 accommodated in the accommodation portions 32 are limited in size and number.

As shown in FIGS. 5a to 5d, desirably, each magnet part 40 includes four to six permanent magnets 41 arranged continuously serially in each accommodation portion 32 in such a manner as to have at least one or more repulsive force generation arrangements. At this time, if the permanent magnets 41 less than six are accommodated in the accommodation portion 32, a filling body 42, which is formed of a non-conductor and has the same size as the permanent magnet 41, is filled in the empty space of the permanent magnet 41 (See FIG. 2a). In this case, if the filling body 42 is filled in the empty space of the permanent magnet 41 and is then accommodated in the accommodation portion 32, another filling body 42 is of course accommodated in another accommodation portion 32 facing one accommodation portion 32 at the corresponding position to the filling body 42 accommodated in one accommodation portion 32.

According to the present invention, most desirably, six permanent magnets 41 are continuously serially arranged in each accommodation portion 32. In this case, the two permanent magnets 41 on both ends of the arrangements of the permanent magnets 41 are arranged with the repulsive forces, and the remaining two permanent magnets 41 disposed between the repulsive force generation arrangements are arranged to generate attractive forces with respect to the repulsive force generation arrangements on both ends of the arrangements of the permanent magnets 41. If the permanent magnets 41 are arranged under the above-mentioned conditions, the repulsive force generation arrangements of one end portion of the accommodation portion 32 and the repulsive force generation arrangements of the other end portion thereof are provided with different poles from each other.

In detail, the arrangements of the permanent magnets 41 are differently made when the permanent magnets 41 are accommodated up and down to apply the attractive forces to the flow path F, and in this case, the arrangements are appropriately and easily selected to improve a degree of ionization of water or dissolution capability for lime melted in water.

So as to improve the lime dissolution capability in water, the number of attractive force generation arrangements is larger than the number of repulsive force generation arrangements in the serially continuous arrangements of the permanent magnets 41, and so as to improve the degree of ionization of water, contrarily, the number of repulsive force generation arrangements is larger than the number of attractive force generation arrangements in the serially continuous arrangements of the permanent magnets 41.

For example, as shown in FIG. 5a, if an N pole, the spacer 50, an S pole, an S pole, the spacer 50, and an N pole are arranged sequentially in the arrangements of the permanent magnets 41 on the upper row with respect to the flow path F, the number of attractive force generation arrangements is equal to the number of repulsive force generation arrangements, thereby allowing the ionization capability of water to be similar to the lime dissolution capability.

As shown in FIG. 5b, if an N pole, an N pole, the spacer 50, an S pole, and an S pole are arranged sequentially in the arrangements of the permanent magnets 41 on the upper row with respect to the flow path F, the number of repulsive force generation arrangements is larger than the number of attractive force generation arrangements, thereby optimizing the water ionization capability.

As shown in FIG. 5c, if an N pole, an N pole, the spacer 50, an S pole, the spacer 50, an N pole, and an N pole are arranged sequentially in the arrangements of the permanent magnets 41 on the upper row with respect to the flow path F, the number of repulsive force generation arrangements is larger than the number of attractive force generation arrangements, in the same manner as FIG. 5b, thereby optimizing the water ionization capability.

As shown in FIG. 5d, if an N pole, an N pole, the spacer 50, an S pole, the spacer 50, an N pole, the spacer 50, an S pole and an S pole are arranged sequentially in the arrangements of the permanent magnets 41 on the upper row with respect to the flow path F, the ratio of the attractive force generation arrangements to the repulsive force generation arrangements is 3:2, thereby optimizing both of the water ionization capability of water and the lime dissolution capability.

As described above, the device for manufacturing magnetized water according to the present invention is configured to allow the accommodation portions, into which the magnet parts are inserted, formed on the outer surfaces of the magnet case to have the open ends formed on outer peripheral surfaces thereof, so that the arrangements of the permanent magnets are arbitrarily changed. Further, the arrangements of the permanent magnets covered with the flow paths are changed by separating the end caps coupled to the longitudinal end portions of the accommodation portions to accommodate the permanent magnets in the accommodation portions, and otherwise, the arrangements of the permanent magnets are changed by separating the end caps to accommodate the permanent magnets in the exchange slider. Accordingly, the arrangements of the permanent magnets in all accommodation portions are arbitrarily changed to optimize water ionization capability or lime dissolution capability according to use purposes of water.

In addition, the device for manufacturing magnetized water according to the present invention is configured to allow at least two or more configurations, each having the accommodation portions facingly disposed, while placing at least two or more flow paths formed in one way therebetween, to be arranged on a horizontal line, so that the distance between the accommodation portions becomes reduced to maximize the magnetization capability for the same volume, and of course, a capacity of magnetization is increased through the plurality of flow paths to allow a large amount of water to be magnetized.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A device for manufacturing magnetized water, comprising:
an outer case (10) formed of a through-body;
an adapter (20) formed of a through-body in such a manner as to be coupled to one end or both ends of the outer case (10);
a magnet case (30) separably accommodated in a through space formed by means of coupling of the outer case (10) and the adapter (20) and having a body (31), accommodation portions (32) facing each other in such a manner as to place a flow path (F) formed in a longitudinal direction of the body (31) therebetween, and end caps (33) disposed on both longitudinal ends of the body (31) in such a manner as to be coupled openably and closably to both ends of the accommodation portions (32), each end cap (33) having a through hole (34) formed thereon to correspond to the flow path (F);
magnet parts (40) each having a plurality of permanent magnets (41) serially continuously arranged and accommodated in each accommodation portion (32) in such a manner as to apply attractive forces to be generated between the accommodation portions (32) in directions facing the accommodation portions (32), the permanent magnets (41) having at least one or more repulsive force generation arrangements in the serially continuous arrangements thereof;
spacers (50) insertedly disposed between the permanent magnets (41) from which the attractive forces are generated in the serially continuous arrangements of the permanent magnets (41) in each accommodation portion (32); and
shield steel plates (60) coupled to the magnet case (30) by means of the magnetic forces of the permanent magnets (41) accommodated in the accommodation portions (32) in such a manner as to cover the longitudinal outer peripheral surfaces of the accommodation portions (32),
wherein the attractive force generation arrangements and the repulsive force generation arrangements of the permanent magnets (41) are arbitrarily changed by means of the magnet case (30) and the end caps (33) separably coupled to each other.

2. The device according to claim 1, wherein if two or more flow paths (F) are formed in the magnet case (30), the flow paths (F) are formed in one way on a vertical section with respect to the longitudinal direction of the body (31), and the accommodation portions (32) face each other on one way line along which the flow paths (F) are formed in such a manner as to place each flow path (F) therebetween, both end accommodation portions (32) on one way line being covered with the shield steel plates (60), so that one set is formed, and one or more sets are formed on a horizontal line.

3. The device according to claim 1, wherein the accommodation portions (32) formed on the longitudinal outer peripheral surfaces of the magnet case (30) have open ends (35) formed on outer peripheral surfaces thereof, so that the attractive force generation arrangements and the repulsive force generation arrangements of the permanent magnets (41) are arbitrarily changed through the open ends (35), and the open ends (35) are shielded by means of the shield steel plates (60).

4. The device according to claim 1, wherein each magnet part (40) comprises six permanent magnets (41) arranged continuously serially in each accommodation portion (32) in such a manner as to have the repulsive force generation arrangements on both ends of the serially continuous arrangements of the permanent magnets (41).

5. The device according to claim 1, wherein each magnet part (40) comprises four to six permanent magnets (41) arranged continuously serially in each accommodation portion (32), and if the permanent magnets (41) less than six are accommodated in each accommodation portion (32), a filling body (42), which has the same size as each permanent magnet (41), is filled in the empty space of the permanent magnet (41).

6. The device according to claim 1, further comprising an exchange slider (70) having an accommodation space (71), support ends (72) disposed on both longitudinal ends of the accommodation space (71), and support bars (73) formed on three surfaces thereof to supportingly connect the support ends (72) thereto, so that after the magnet part (40) is accommodated in the accommodation space (71) of the exchange slider (70), the exchange slider (70) is accommodated in the accommodation portion (32).

7. The device according to claim 2, wherein the body (31) having two or more flow paths (F) in one way on the vertical section with respect to the longitudinal direction of the magnet case (30) comprises: end bodies (31a) each having a half flow path (hF) left with half of each flow path (F) and the accommodation portion (32) whose open end (35) or closed end (35′) is formed on the outer surface facing the half flow path (hF); and a connection body (31b) having half flow paths (hF) facingly formed on both sides thereof, while placing the accommodation portion (32) therebetween, in such a manner as to correspond to the half flow paths (hF) of the end bodies (31a), so that the half flow path (hF) of the connection body (31b) or the end body (31a) is coupledly connected to both side half flow paths (hF) of the connection body (31b) to form the body (31), and the end bodies (31a) are disposed on both ends of the body (31) coupled in one way.

8. The device according to claim 2, wherein the accommodation portions (32) formed on the longitudinal outer peripheral surfaces of the magnet case (30) have open ends (35) formed on outer peripheral surfaces thereof, so that the attractive force generation arrangements and the repulsive force generation arrangements of the permanent magnets (41) are arbitrarily changed through the open ends (35), and the open ends (35) are shielded by means of the shield steel plates (60).

9. The device according to claim 2, wherein each magnet part (40) comprises six permanent magnets (41) arranged continuously serially in each accommodation portion (32) in such a manner as to have the repulsive force generation arrangements on both ends of the serially continuous arrangements of the permanent magnets (41).

10. The device according to claim 2, wherein each magnet part (40) comprises four to six permanent magnets (41) arranged continuously serially in each accommodation portion (32), and if the permanent magnets (41) less than six are accommodated in each accommodation portion (32), a filling body (42), which has the same size as each permanent magnet (41), is filled in the empty space of the permanent magnet (41).

11. The device according to claim 2, further comprising an exchange slider (70) having an accommodation space (71), support ends (72) disposed on both longitudinal ends of the accommodation space (71), and support bars (73) formed on three surfaces thereof to supportingly connect the support ends (72) thereto, so that after the magnet part (40) is accommodated in the accommodation space (71) of the exchange slider (70), the exchange slider (70) is accommodated in the accommodation portion (32).
